(19) United States
(12) Patent Application Publication
(10) Pub. No.: US 2016/0098654 A1
(43) Pub. Date: Apr. 7, 2016

(54) DATA QUALITY ANALYSIS TOOL

(71) Applicant: MORGAN STANLEY, New York, NY (US)

(72) Inventors: Gaurab Bhattacharjee, Morristown, NJ (US); Peter Y. Choe, Northvale, NJ (US)

(73) Assignee: MORGAN STANLEY

(21) Appl. No.: 14/503,959

(22) Filed: Oct. 1, 2014

(51) Int. Cl. G06Q 10/06

(52) U.S. Cl. CPC G06Q 10/0637

(57) ABSTRACT

A data quality analysis tool and method for determining the business impact of a data set utilizing weighting and rule priority. The data quality analysis tool including a Rules Engine and a Scoring Engine. The Scoring Engine is configured to i) for each specific rule that has been met, determine a business impact score, ii) apply a weighting factor to each of the business impact scores to obtain a weighted business impact for each of the at least one specific rules, and iii) compute priority of the weighted business impact scores into a total business impact score.

### FIELD OF THE INVENTION

This disclosure relates generally to data quality analysis and, more particularly, to computerized tools for use in data quality analysis.

### BACKGROUND

Data quality issues are prevalent in every organization. If you go to almost any organization in the world, despite the diversity, and ask for a quality report on a data set you will essentially get the same type of report regardless of where you are. The report will include the number of “things” (i.e., whatever is being measured) that either passed (or failed) a test compared to the entire population measured, often presented as a percentage, weighted average or ratio.

Data quality, by itself, however, is insufficient to make a business decision. The major obstacle with this approach is that pure percentages may mean nothing to a decision maker. Two data quality issues with the same percentage of failed/bad records may appear to someone evaluating the report as being equivalent, even though the business impact may be significantly different. As a result, companies are not able to make business decisions related to the data.

### BRIEF SUMMARY

In one aspect of this disclosure, a computerized data quality analysis tool, including one or more processors, coupled to non-transient program and data storage, configured to operate, under the control of a non-transient program, the non-transient program comprising, when executed, to implement a Data Quality Rules Engine (DQRE), a Scoring Engine and a Configuration Management Engine. The DQRE is configured to i) allow one or more rules to be entered and stored in the data storage, ii) receive a data set, comprised of one or more data record, iii) determine whether any of the received data set meets at least one specific rule, iv) for each instance where the at least one specific rule is met, determine one or more business impacts, and v) allow a priority associated with each rule to be entered and stored in the data storage. The Scoring Engine is configured to i) for a specific rule, determine a business impact score, ii) apply a weighting factor to each of the one or more business impact scores to obtain a weighted business impact for each of the at least one specific rules, and iii) compute priority of the weighted business impact scores into a total business impact score. The Configuration Management Engine, includes an Alerts and Notification module, wherein the Configuration Management Engine is configured to provide notifications to a subscribed user via the Alerts and Notification module based upon a result of the Scoring Engine performing “iii)”.

In another aspect of this disclosure, a computer implemented method for assessing the impact of data quality on a business, includes retrieving, using a processor, at least two or more data quality rules, wherein each of the at least two or more data quality rules has a rule criteria that must be met and an association to instructions for determining at least one or more Impact Metrics. A data set containing one or more data records is retrieved and separately analyzed, using the processor, for each of the at least two or more data quality rules. Separately for each of the at least two or more data quality rules, using the associated instructions for determining the at least one or more Impact Metrics, one or more Impact Metrics are determined according to the formula

$$f ( I ) = {\sum }_{1}^{n} \frac{{I}_{i}}{{T}_{i}}$$

where f(I) is Impact Metric, Iᵢ is the actual determined impact of the records meeting the rule criteria for the data quality rule, and Tᵢ is the total possible impact over the records in the population. Separately for each of the at least two or more data quality rules, a weighting factor is applied to the at least one or more Impact Metrics and a weighted business impact is produced according to the formula

$$f ( w ) = \frac{{\sum }_{1}^{n} f ( I ) \times {w}_{n}}{{\sum }_{1}^{n} {w}_{n}}$$

where f(w) is the weighted Impact Metric for a particular rule, against which the database is accessed; f(I) is the impact of an Impact Metric; and wₙ is the weighting factors for each metric. A total business impact score for the data set is calculated, using the processor, according to the formula

$$f ( S ) = {\sum }_{1}^{n} f ( w ) \times f ( P )$$

where f(P) is a rule priority applicable to each of the at least two or more data quality rules, wherein the total business impact score corresponds to the magnitude of impact on the business.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a general functional overview of a process for computing a Total Business Impact Score;

FIG. 2 illustrates, in simplified form, an exemplary implementation of the process of FIG. 1;

FIG. 3A illustrates, in simplified form, a diagram related to defining a rule;

FIG. 3B illustrates, in simplified form, a diagram related to executing a rule;

FIG. 4A illustrates, in simplified form, an exemplary system architecture, which is capable of, and as shown used for, implementing the process specified in FIG. 1;

FIG. 4B illustrates, in simplified form, additional details of the presentation layer module of FIG. 4A;

FIG. 4C illustrates, in simplified form, additional details of the processing engines of FIG. 4A;

FIG. 4D illustrates, in simplified form, an exemplary Data Repository suitable for use in implementing variants of the architecture described herein;

FIG. 5 illustrates, in simplified form, a sample output Executive Score Card, which allows a viewer to quickly assess business impact as it relates to the data being analyzed;

FIG. 6A illustrates, in simplified form, the output from a first analysis of a data set using the approach described herein;

FIG. 6B illustrates, in simplified form, the output from a subsequent analysis of the data set;

FIG. 6C illustrates, in simplified form, an output identified as “Fixed” records;

FIG. 6D illustrates, in simplified form, an output identified as “New” records;

FIG. 6E illustrates, in simplified form, an output identified as “Unchanged” records;

and

FIG. 6F illustrates, in simplified form, an output identified as a “Changed” records.

### DETAILED DESCRIPTION

This disclosure provides a technical solution to address the problem that business decisions are being made based upon metrics related to whether or not the data is good or bad, without regard to the relative business impact of the data quality. As such, businesses often make bad decisions and improperly allocate resources, away from the real problem, based upon invalid or incomplete information.

To address the problem, knowing that a data set is good or bad is not enough. In actuality, a large, seemingly good, data set, with a single bad record, could have a huge business impact and require immediate remediation. On the other hand, a data set, with numerous bad records, could actually have no measurable business impact at all, and require no action by the company. It should be pointed out that the business impact need not necessarily be negative. For example, in the abstract, closing a deal ahead of schedule generally has a positive business impact. Likewise, closing a deal plagued with multiple delays will generally be considered to have a negative business impact. However, without knowing whether the closed deals are deals representing simply a few thousand dollars or several million dollars, it is impossible to understand the specific level of business impact. In other words, a delay (positive or negative) that affects a multi-million dollar deal by a few thousand dollars may be meaningless, whereas the same delay and cost for closing a deal of under one hundred thousand dollars could be very significant.

The technical solution described in this disclosure is implemented as an automated approach that combines determining one or more measurable business impacts when a data record passes/fails one or more data rules, and further incorporates prioritizing those rules, in order to produce a “Total Business Impact Score” that can be used to make better business decisions, because it takes into account the relative impact to the business of any bad data. Moreover, it allows the business to target, prioritize, and devote resources to, remediation of bad data that has a real business impact.

A general overview of the technical approach to solving the problem of not being able to assess the business impact of a data set (positive or negative) will now be provided, followed by a more detailed description of the components of the process and the process itself.

Today, data quality typically gets measured in basic percentages of good and bad records. However, raw percentages of good and bad records do not indicate whether the issues represented by those percentages indicate a critical issue or not. In other words, it does not include a measure of the business impact. There are many cases where there can be a data quality issue on a non-critical field that, although it may need to be addressed, does not affect the day-to-day business. For example, a data quality issue involving a large number of misspellings of a particular word may have little to no impact, whereas a single digit error in a single account number can have a massive impact.

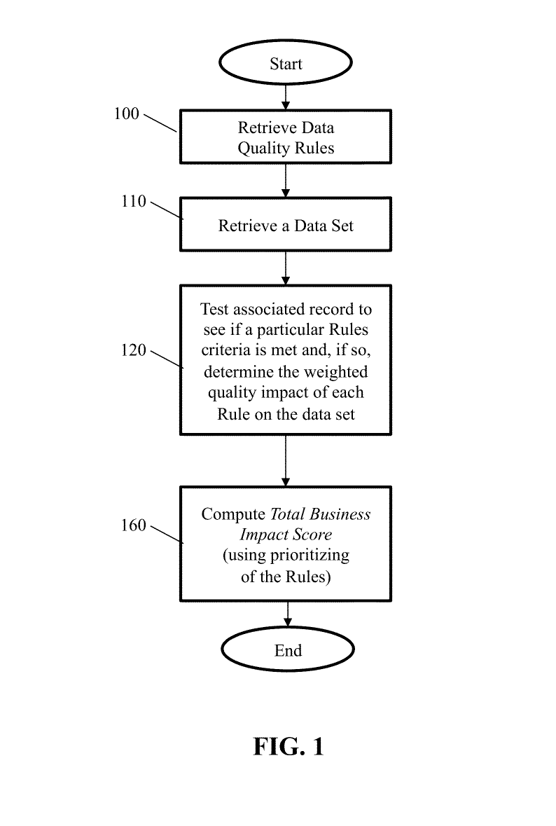

With the foregoing in mind, a functional overview of a tool and approaches for use in solving the problem of not being able to assess the business impact of a data set will now be provided with reference to FIG. 1.

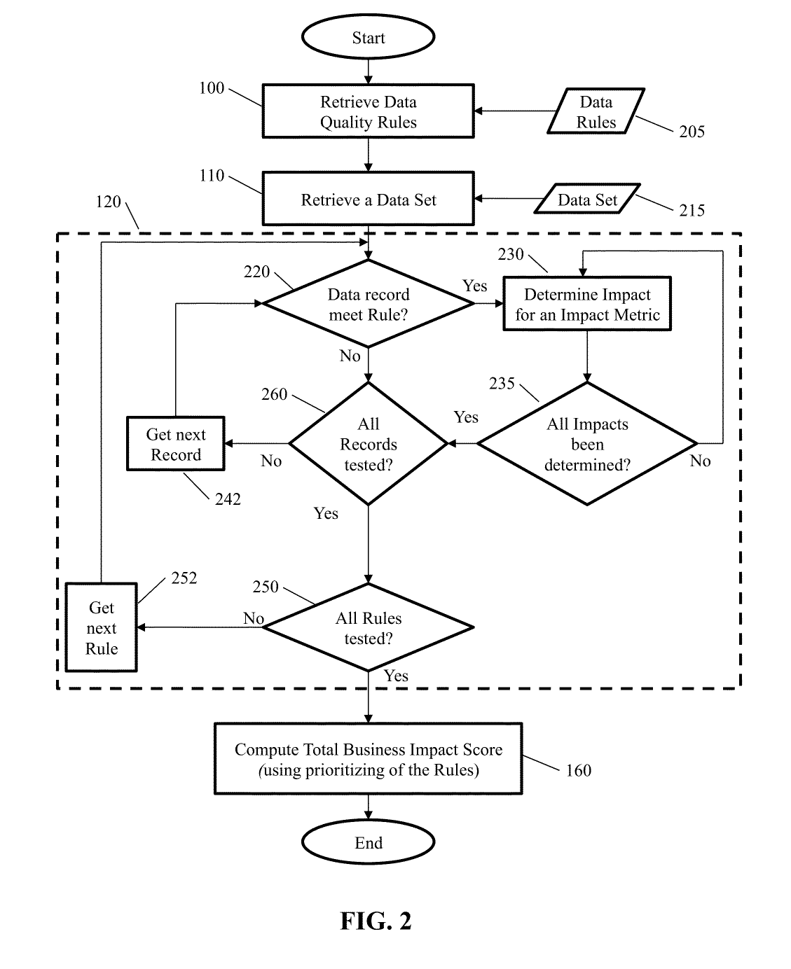

FIG. 1 illustrates, in simplified form, a general functional overview of a process for computing a Total Business Impact Score. FIG. 2 illustrates, in simplified form, details involved in computing a Total Business Impact Score for one exemplary implementation of the process of FIG. 1.

In order to create a Total Business Impact Score for a data set that incorporates the business impact of a data quality issue, we first calculate an “Impact Metrics.” Impact Metrics are tangible and quantifiable measures that can be used to determine the degree of impact a data quality issue has on a business area. For example, if a data quality issue impacts customer accounts, an appropriate example Impact Metric may be the number of affected accounts. Another example Impact Metric might be the dollar value of the accounts impacted. Still another example of an Impact Metric might be the magnitude of the error, for instance, is the magnitude $0.001 or $1,000.00.

Referring to FIG. 1, the first step in computing a Total Business Impact Score is to retrieve the data quality rules (Step 100). In general, a rule (or data rule) is a set of instructions used to determine whether a record within a data set meets a criteria, a “rule criteria”, such that the data record can be determined as either good or bad and may exist in the prior art or be newly created. A “data quality rule” is a rule that additionally has one or more associated Impact Metrics and also a priority relative to the other rules being applied to the data being analyzed.

After the rules have been retrieved, the next step is to retrieve a data set (Step 110), containing one or more data records, that will be analyzed using the data quality rules. These data sets would generally be the same data as other data sets conventionally used in current analysis approaches. As will be discussed in greater detail below, the analysis involves testing associated records to see if a particular rule's criteria is met and, if so, determining a “Weighted Quality Impact” (also discussed in greater detail below) for each applied data quality rule on the data set (Step 120). Finally, those results are used to compute a Total Business Impact Score (Step 160).

It is understood that, depending on how a particular rule is formulated, passing or satisfying the rule can be either good or bad. For example, if the rule is written in the affirmative (e.g., “Do the values all have two digits following the decimal point?”) a “YES” may indicate “good” data, whereas if the data quality rule is written in the negative (e.g., “Do any of the values lack two digits after the decimal point?”) a “NO” may indicate “good” data. In the same vein, failing a rule can be either a good or a bad thing, depending upon how the rule is written. Additionally, simply by adding a logical “NOT” to the outcome of a testing of a data record against a rule, a rule can easily be changed such that a test for “good” data becomes a test for “bad” data, or vice versa. In instances, where simply adding a logical “NOT” is insufficient to fully transform a rule written to test for “good” data into a test for “bad” data, or vice versa, it is known in the art that, through the use of logic and/or possible rewording, a rule can be so transformed. As such, since current data quality reports created according to conventional approaches are typically associated with how much “bad” data is in a data set, the following discussion herein will be such that meeting the criteria of a data quality rule is indicative of a bad outcome (a “break”), with a negative business impact, with the understanding that the disclosure herein can alternatively be implemented such that, and should be understood as equally applicable to, cases where meeting the criteria of a rule indicates a “good” outcome, with a positive business impact.

The Weighted Quality Impact is determined based upon a set of instructions associated with each individual Impact Metric, which are further associated with each particular data quality rule. For example, for a particular rule that deals with securities, a first associated Impact Metric might be the number of accounts and a second associated Impact Metric might be the amount of holdings affected, the data for which might reside in a second data source. While these instructions may generally be expressed in natural language form, it is understood that other expression forms, such as (but not limited to) mixes of natural language and logic symbols, and/or specific pre-defined syntax may also be used in some implementations.

The instructions associated with the first Impact Metric might be, for example, to access the account holdings database and determine how many accounts corresponded with the particular record that meet the criteria for a particular data quality rule. Similarly, the instructions associated with the second Impact Metric might be, for example, to access the account holdings database and determine the sum of all the holdings in each account that corresponded with the particular record that met the criteria for another data quality rule.

While the Impact Metric could simply be a count or a sum, as specified above for the first and second Impacts Metrics respectively, simply using these types of metrics can be misleading because they can be greatly impacted by the size of the data set. Advantageously, by using an Impact Metric that is a percentage of the total data associated with that Impact Metric that could have been impacted, eliminates the effect of data set size on the impact when comparing the results of one data set to another.

Therefore, a more desirable set of instructions for the first Impact Metric might be, for example, to access the holdings account database and determine what percentage of accounts corresponded with the particular record that met the criteria for the rule. Similarly, a more desirable set of instructions for the second Impact Metric might be, for example, to access the holdings account database and determine the percentage of all the holdings in each account that corresponded with the particular record that met the criteria for a particular rule.

An Impact Metric based upon a percentage of the total data associated with that Impact Metric that could have been impacted is specified by the following equation:

$$f ( I ) = {\sum }_{1}^{n} \frac{{I}_{i}}{{T}_{i}} \qquad Eq . ( 1 )$$

where f(I) is the sum of the actual determined impact of a record meeting the criteria of a rule divided by the total possible impact that could have occurred, Iᵢ is the actual determined impact of the record, and Tᵢ is the total possible impact over the records in the population.

The use of Impact Metrics, and in particular the use of Impact Metrics that are based upon a percentage of the population that could have been impacted, are tremendously advantageous over the current practice of simply reporting the percentage of good/bad data records when trying to make a business decision. The use of Impact Metrics advantageously allows someone to make better decisions, particularly when the Impact Metric is based on a percentage that could have been impacted, since this readily allows the comparison of one data set to another by removing the effect of data set size on the impact.

In the example being discussed so far, the rule being tested resulted in two Impact Metrics: 1) number of accounts impacted, and 2) dollar value of accounts impacted. When there is only a single rule with a single associated Impact Metric, then determining a Total Business Impact Score can be done by simply summing up the individual Impact Metrics. However, not all Impact Metrics have the same business impact. Therefore, when determining the Impact Metrics, it is advantageous to introduce a weighting factor(s) that will be associated with each Impact Metric (an “Impact Metric Weighting Factor”) so that a better picture of the true business impact emerges from the analysis.

For example, the first Impact Metric related to the number of accounts impacted may be far less important than the number or dollar amount of affected holdings. While the Impact Metric Weighting Factor could be any number (including negative number, which would change the nature of the impact from bad to good, or vice versa), using real numbers that range from 0 to 1 is advantageous as it more easily allows impacts to be compared.

However, having weights within the range of 0 to 1 in not necessary and the more general form for computing the weighted impact is to simply sum the combined Impact Metric Weighting Factors and the impact determined by application of each Impact Metric, and then divide the result by the sum of the weighting factors for each metric, which can be expressed by the equation below:

$$f ( w ) = \frac{{\sum }_{1}^{n} f ( I ) \times {w}_{n}}{{\sum }_{1}^{n} {w}_{n}} \qquad Eq . ( 2 )$$

where f(w) is the weighted Impact Metric for a particular rule, against which the database is accessed; f(I) is the impact of an Impact Metric; and wₙ is the weighting factors for each metric.

Additionally, the weights can also be adjusted from time to time to allow for more of a heuristic approach to producing Total Business Impact Score. By setting the weights differently for Impact Metrics, it may affect the Total Business Impact Score in positive or negative manner. This will allow users to determine, through learning and experience, what the best allocations and settings are for their requirements. Additionally, the weighting factor need not be a single value but could be based on the value of the measured impact and could be computed using an equation, for example, wₙ=af(I)+b, where a an b are constants, or wₙ=1/f(I) or other standard techniques, such as the use of a look-up table specifying the value of wₙ when the value of f(I) falls within certain ranges, the key point being that the Impact Metrics are combined in a pre-determined manner that helps the decision maker make effective business decisions, not the particular technique or protocol used to combine the Impact Metrics.

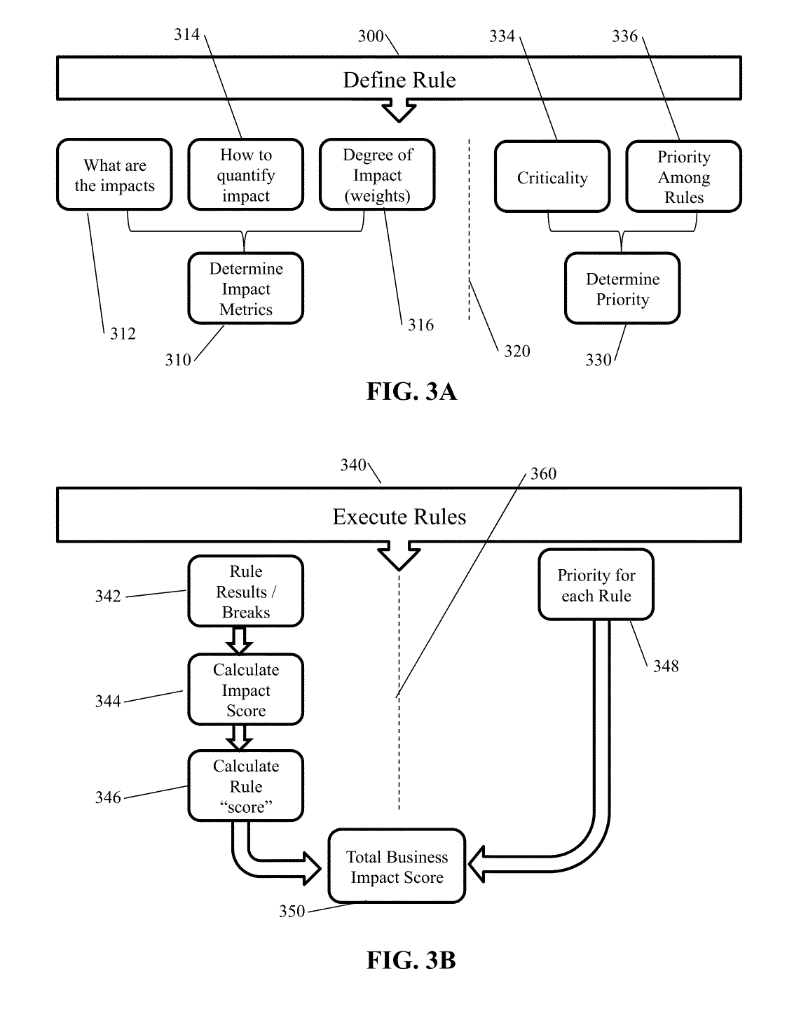

FIG. 3A illustrates, in simplified form, a diagram related to defining a rule and FIG. 3B illustrates, in simplified form, a diagram related to executing a rule. FIGS. 3A and 3B are helpful to examine in terms of understanding the interplay between rules and Impact Metrics.

At this point, it is useful to understand that determining the Impact Metrics is a component part of defining the rules, as can be seen in FIG. 3A to the left of the dashed line 320. A component of defining a rule 300 involves determining the Impact Metrics 310 associated with the rule and involves: assessing what are the impacts 312 of a break in the rule, determining the steps of how to quantify the impact 314, and specifying a degree of impact (weights) 316 when one impact for a particular rule is compared to another.

Once the individual Impact Metrics have been determined, they can then, as seen in FIG. 3B (to the left of the dashed line 360), be used in executing the rule 340. Executing the rule involves determining the rule results/breaks 342 for the records of a data set and then calculating the Impact Metrics 344 associated with the rule, and then combining them together to calculate a rule “score” 346, which is the weighted impact of all of the associated Impact Metrics of a particular rule.

Referring back to FIG. 1, once all the rule scores for each rule have been determined (Step 120), the next step is to compute the Total Business Impact Score (using the priority of the rules) (Step 160). However, in order to use priority of the rules, that priority of the rules must be determined, which is also shown in FIG. 3A (to the right of the dashed line 320). Referring to FIG. 3A, determining the priority 330 of one rule compared to another involves assessing the criticality 334 of a rule and, based upon that criticality 334, prioritizing the rules 336 relative to each other.

Then, in executing the rules as shown in FIG. 3B, the priority for each rule 348 and the rule score 346 for each rule are combined together to obtain or calculate the Total Business Impact Score 350.

Determining the priority of one rule with respect another can be accomplished in any of a number of different methods. For example, Rule1, Rule2, Rule and Rule4 could be respectively assigned the values of 1, 2, 3, and 4, with, for example, “1” being the highest priority rule and “4” being the lowest priority rule, or vice versa. Alternatively, by way of example, Rule1, Rule2, Rule3 and Rule4 could be respectively assigned an arbitrary priority value of 38, 5, 5 and 19, reflective of an importance or degree of priority. It is understood that priority values need not be sequential and two or more rules can have the same value. The point is not the particular values selected, but rather that the values selected make business sense to the individual using them. Thus, advantageously, for different parts of a business, different users may set different priority values for analyzing the same data set as appropriate to their particular needs.

While the priority values assigned could be any real number, it is preferable to use rule normalization in order to determine the priority value of a rule, so that the Total Business Impact Score produced can be readily compared among various data sets.

With rule normalization techniques, the rules are first put in a sequential order with the highest priority rule having a value of 1. An equation for normalizing each rules is:

$$f ( P ) = \frac{r - P + 1}{r} \qquad Eq . ( 3 )$$

where f(P) is the normalized priority, r is the number of rules and P is the priority of the rules. For example, if Rule1, Rule2, Rule3 and Rule4 were respectively given the values of 1, 2, 3 and 4, then their respective normalized priority values would be Rule1=(4−1+1)/4=1.00, Rule2=(4−2+1)/4=0.75, Rule3=(4−3+1)/4=0.50, and Rule4=(4−4+1)/4=0.25.

No matter how the rules are prioritized, once they have been prioritized, computing the Total Business Impact Score is mathematically done using the following formula:

f(S)=Σ₁ⁿf(w)×f(P) Eq. (4)

where f(S) is the sum of all the individual rules' weighted Impact Metrics multiplied by their priority, f(w) is the weighted Impact Metric for a particular rule, and f(P) is the priority of the rule (normalized or otherwise).

As previously mentioned, FIG. 2 represents an example implementation of the process for computing a Total Business Impact Score illustrated in FIG. 1 and will now be discussed.

With reference to FIG. 2, the data quality rules 100 may be retrieved from a data rules database 205, which may be incorporated as a component of a single data processing system or information queried from a secondary server. Similarly, the data set 110 may be retrieved from a data set database 215, which may be incorporated as a component of a single data processing system or information queried from a secondary server.

The step of testing associated records to see if a particular rules criteria is met and, if so, determining the weighted quality impact of each rule on the data set (Step 120 of FIG. 1) has been expanded upon in FIG. 2 to show one implementation of how the testing can be accomplished. The initial step involves determining whether a particular data record meets a rule 220. If yes, then the next step is to determine the impact for an Impact Metric 230 until all impacts have been determined 235. Once all the impacts have been determined (or if the record did not meet the rule 220 originally), then the next step is to determine if all records have been tested 260 and, if not, get the next record 242 and test the next record against the rule 220. Once all the records have been tested 260, then the next step is to determine if all the rules have been tested 250 and, if not, get the next rule 252 and test the next record against the rule 220. If all of the rules have all been tested, then the process proceeds to computing the Total Business Impact Score (using rule prioritization) 160.

FIG. 2 represents testing each of data rules 205 sequentially against each record in the data set 215. It should be understood by those knowledgeable in the art that an alternative and equally appropriate approach would be to test each record in the data set 215 sequentially against each rule and the data rules 205.

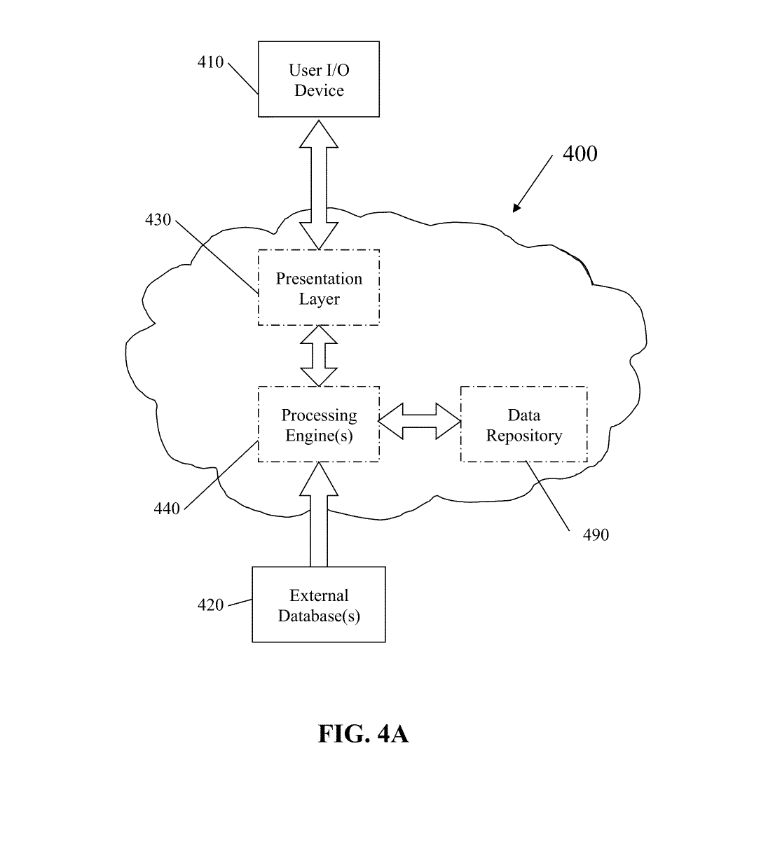

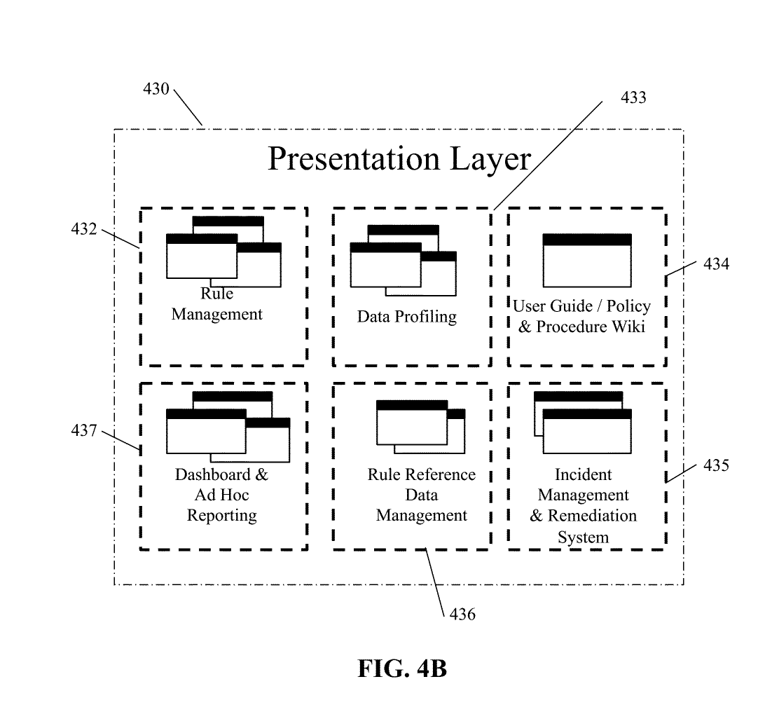

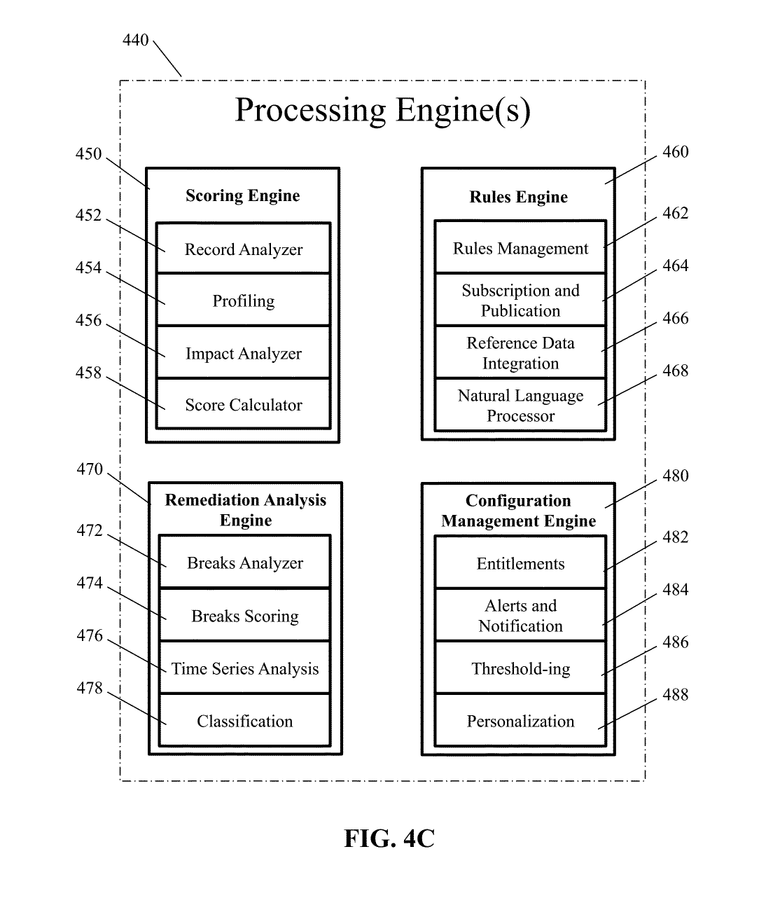

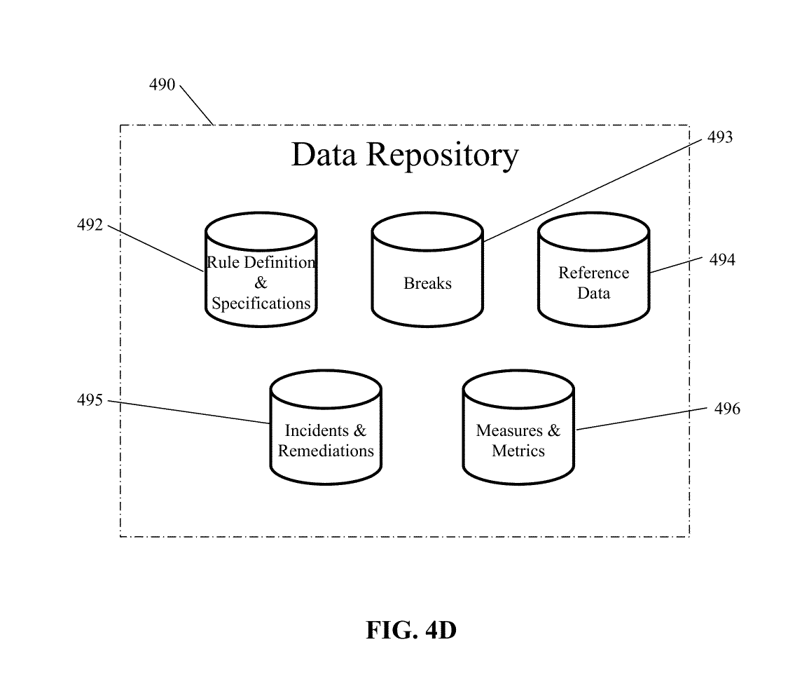

Having represented the technical solution herein by way of the process flows involved with reference to FIGS. 1, 2 and 3A-3B, an example architecture for implementing the above process flows will now be presented. FIG. 4A illustrates, in simplified form, an exemplary system architecture 400, which is capable of, and as shown used for, implementing the process specified in FIG. 1, coupled with a User I/O Device 410 and one or more External Databases 420. Within the architecture 400 is a presentation layer module 430, which is used to create the interface that an end user interacts with (through the User I/O Device 410) in order to provide input to and receive output from the system; one or more processing engines 440, which are used to process information, perform data analysis and produce output as described herein; and a data repository 490, which is used to store data used by the system for the purpose of processing information, performing data analysis and producing output. All of the components within the architecture 400 could all be part of a single system or one or more separate systems as indicated. As shown, the architecture 400 is implemented using a combination of computer hardware and software. From a hardware perspective, the architecture 400 is made up of one or more processors coupled to non-transient program and data storage. The one or more processors operate, under program control, to cause the processes described herein to be performed, and thereby collectively realize a physical manifestation of the processing engines 440.

The presentation layer module 430 is responsible for generating the user interface, which improves the user experience by enhancing the user's ability to interact with and control the system. The presentation layer module 430 is likewise implemented using a combination of computer hardware and stored program software. Specifically, the presentation layer module 430 uses one or more of the processors of the architecture, for example, one or more microprocessors and/or graphics processing units (GPUs), operating under control of the stored software to accomplish its designated tasks as described herein. At this point, it should be recognized that the process illustrated in FIG. 1 does not actually require user input in order to function. Instead, retrieval of the rules and the data set could be hard coded into the system such that it can be set to automatically, periodically, operate to access data and analyze it for business impact as described herein.

FIG. 4B illustrates, in simplified form, additional details of the presentation layer module 430. As shown, the presentation layer 430 module includes a Rules Management module 432,which allows the user to specify parameters about rules (e.g., Impact Metrics, weighting factors, priority, etc.); a Data Profiling module 433, which allows the user to select particular aspects of the data that they want to get information about; a User Guide/Policy & Procedure Wiki 434 service, which guides the user in using the system; an Incident Management & Remediation System module 435, which provides a user interface for tracking and monitoring requests for corrective action (incidents) based upon review of the data (based upon the Total Business Impact Score); a Rule Reference Data Management module 436, which allows rules to be grouped together into categories such as (but not limited to) Topics (e.g., Mortgage Origination, Mortgage Closing . . . etc.), Domain (e.g., Closing, Boarding, Property . . . etc.), and Type (e.g., Operational, Validity . . . etc.); and a Dashboard & Ad Hoc Reporting module 437, which provides summary information and displays data analysis across the data groupings.

FIG. 4C illustrates, in simplified form, additional details of the processing engine(s) 440. As shown, the Processing Engine(s) 440 include a Scoring Engine 450, a Rules Engine 460, a Remediation Analysis Engine 470 and a Configuration Management Engine 480. Depending upon the particular implementation variant, any one or more of the Rules Engine 460, Remediation Analysis Engine 470 and Configuration Management Engine 480 can be omitted, as they are optional.

The Processing Engine(s) 440 are implemented using a combination of computer hardware and stored program software. Specifically, the Processing Engine(s) 440 use one or more of the processors of the architecture, for example, one or more microprocessors, operating under control of the stored software to accomplish its designated tasks as described herein. As shown, the Scoring Engine 450 is made up of special purpose sub-modules including a Record Analyzer module 452, a Profiling module 454, an Impact Analyzer module 456 and a Score Calculator module 458. It should be understood, however, that only the Record Analyzer module 452, Impact Analyzer module 456 and Score Calculator module 458 of the Scoring Engine 450 are actually required to implement the process as described herein (i.e., the Profiling module 454 is optional).

The Record Analyzer module 452 is used to determine if the criteria of a rule is met. The Profiling Engine module 454 is used to categorize the records being analyzed according to the previously mentioned groups (e.g., Topics, Domain and Type for later data analysis). The Impact Analyzer module 456 is used to determine the business impact when the criteria of a rule is met and specifically implements at least Equations (1) and (2), and optionally Equation (3) if Equation (3) is not otherwise implemented within the Score Calculator module 458. The Score Calculator module 458 specifically implements at least Equation (4), and optionally Equation (3) if Equation (3) is not otherwise implemented within the Impact Analyzer module 456, such that the Processing Engine(s) 440 can use the business impact of the rules to calculate the Total Business Impact Score for the data set being analyzed.

The (optional) Rules Engine 460 includes a Rules Management module 462, which allows rules to be created and edited; a Subscription and Publication module 464, which allows users to be subscribed to certain rules and receive reports based upon, for example, particular rules criteria being met or failed, and/or to subscribe to receive any analysis involving specific rules specified by a user; a Reference Data Integration module 466, which specifies the methods for retrieving the external data from specific source(s); and, optionally, a Natural Language Processor 468, which allows rules to be written by an end user using natural language and then converts the natural language rules into executable instructions to be processed by the Scoring Engine 450. The Rules Engine 460 is also implemented using a combination of computer hardware and stored program software. Specifically, the Rules Engine 460 uses one or more of the processors of the architecture, for example, one or more microprocessors, operating under control of the stored software to accomplish its designated tasks as described herein.

The (optional) Remediation Analysis Engine 470 allows the user to make a more detailed analysis of the data and includes a Breaks Analyzer module 472, which allows a particular type of failure to be analyzed either within a single data set or across data sets; a Breaks Scoring module 474, which implements Eq. (1) and Eq. (2) to calculate an Impact Metric score within a single data set or across data sets; a Time Series Analysis module 476, which allows a particular type of failure to be analyzed over time either within a single data set or across data sets; and a Classification module 478, which conducts analysis based upon the previously mentioned groups (e.g., Topics, Domain and Type). The Remediation Analysis Engine 470 is implemented using a combination of computer hardware and stored program software as well. Specifically, the Remediation Analysis Engine 470 uses one or more of the processors of the architecture, for example, one or more microprocessors, operating under control of the stored software to accomplish its designated tasks as described herein.

The (optional) Configuration Management Engine 480 includes an Entitlements module 482, which is where security is implemented to control access to specific rules and reports based upon each user's credentials; an Alerts and Notification module 484, which handles reporting to users based upon one or more of either their credentials and/or the subscribed-to rules; a Threshold-ing module 486, which is used to determine when an alert or notification is to be issued based upon Impact Metrics and can either be set based upon any one or more of: a user's subscriptions to rules, user credentials and/or other individual user criteria; and a Personalization module 488, which is where individualized settings are managed. As with the other engines, the Configuration Management Engine 480 is implemented using a combination of computer hardware and stored program software. Specifically, the Configuration Management Engine 480 likewise uses one or more of the processors of the architecture, for example, one or more microprocessors, operating under control of the stored software to accomplish its designated tasks as described herein.

FIG. 4D illustrates, in simplified form, an exemplary Data Repository 490 suitable for use in implementing variants of the architecture described herein. The Data Repository 490 is implemented as non-volatile storage that can take any appropriate form, including (but not limited to) disk, tape, solid-state memory or other storage media and is configured to be accessible to the engine(s) described herein as necessary. As shown, the Data Repository 490 includes a Rule Definition & Specifications repository 492, which is a container for storing the definition and the specifications of rules, Impact Metrics as well as weights for a rule; an optional Breaks repository 493, which is a container for storing rule breaks, which will be point-in-time snapshots of data source records, with ties to previously mentioned groups (e.g., Topics, Domain and Type) through metadata; an optional Reference Data repository 494, which is a container for creating, modifying or deleting the previously mentioned groups (e.g., Topics, Domain and Type); an optional Incidents & Remediations repository 495, which is a container for storing incidents for issues with Data Quality and metrics related to Remediation Analysis engine 470; and an optional Measures & Metrics repository 496, which is a container for storing time-series storage of rule results (break counts) and Impact Metrics enriched with previously mentioned groups (e.g., Topics, Domain, and Type) through metadata. Depending upon the particular implementation variant, one or more of the optional repositories can also be incorporated.

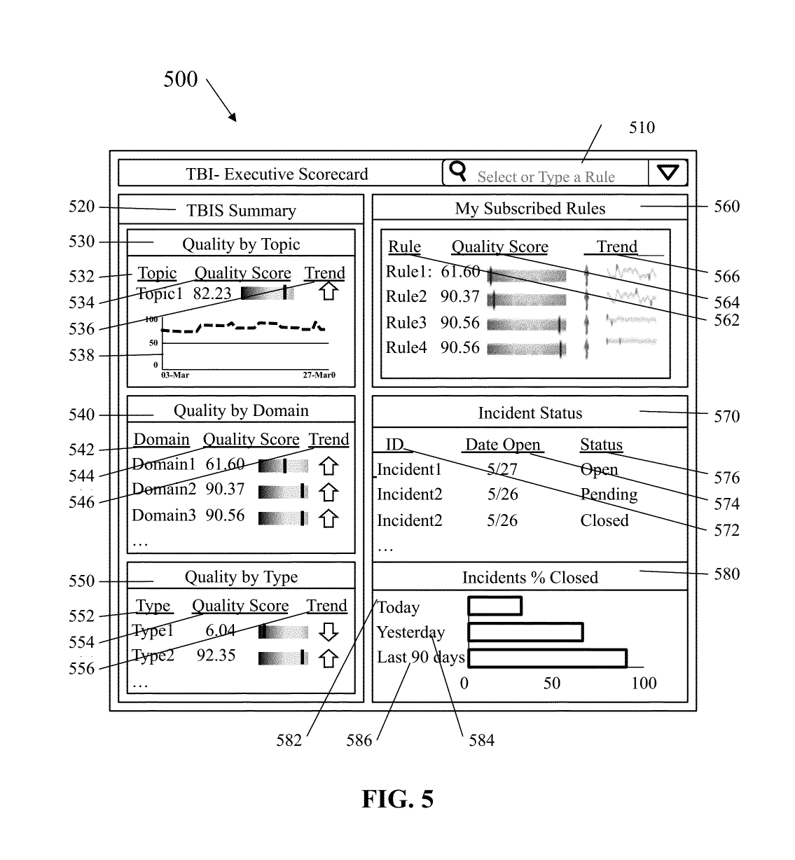

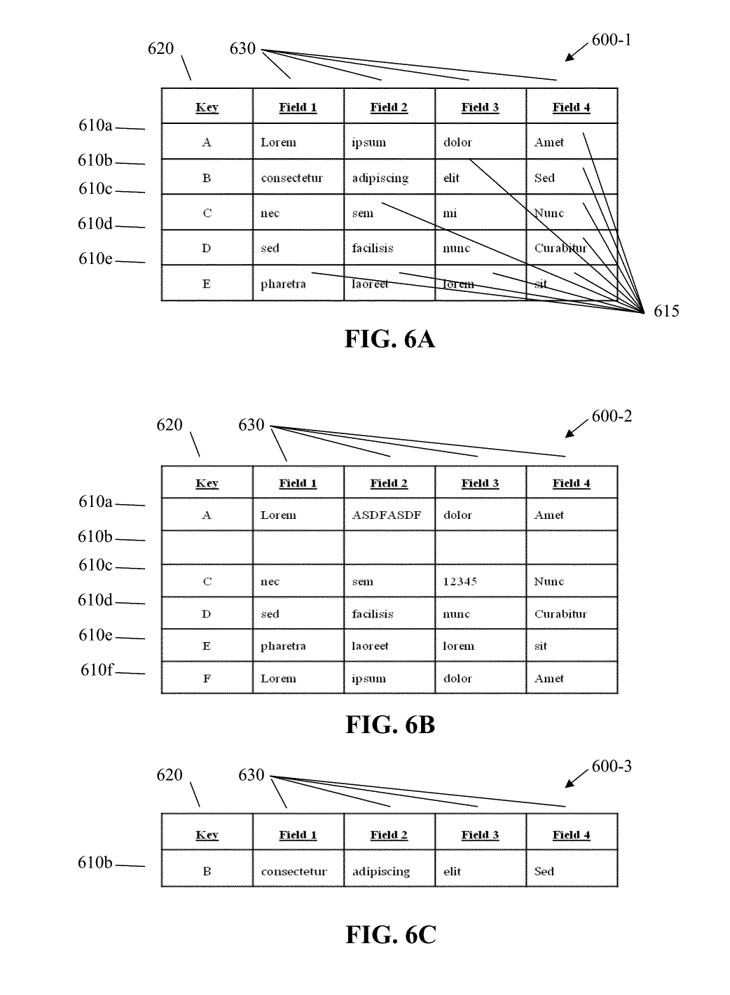

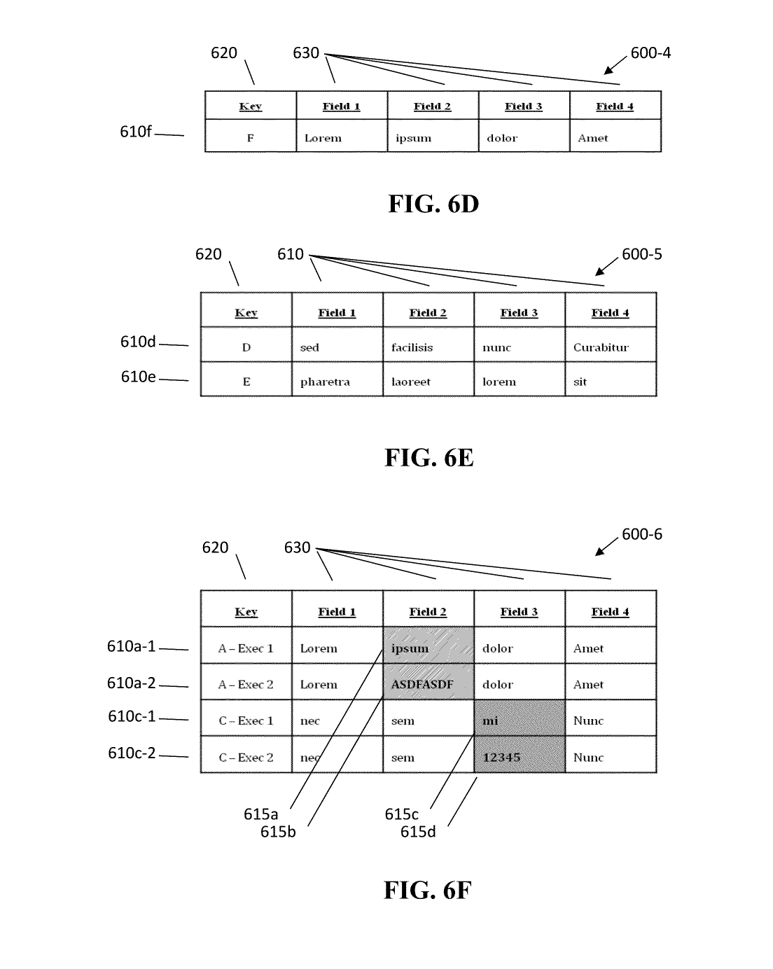

Having represented the technical solution herein by way of the process flows involved with reference to FIGS. 1, 2 and 3A-3B, and an example implementation illustrated in FIGS. 4A-4D, it is helpful to look at some representative system outputs and data as represented in FIGS. 5 and 6A-F.

FIG. 5 illustrates, in simplified form, a representative output Executive Score Card 500, which allows a viewer to quickly assess business impact as it relates to the data being analyzed. Specifically, the Executive Score Card 500 is an example of an interface through which results of the operation of the Processing Engine(s) 440 can be viewed. The Executive Score Card 500 is output by the Dashboard & Ad Hoc Reporting module 437 of FIG. 4B using information generated through application of the rules and Equations (1)-(3) to the data being analyzed. As shown in FIG. 5, the Executive Score Card 500 includes a search tool 510, which can be used to select a particular rule for which the data will be displayed and helps a viewer key in on specific problem areas. Additionally, the Executive Score Card 500 includes a Total Business Impact Score (TBIS) Summary 520 section, which provides summary information based upon available groupings. In the example implementation shown, the groupings are Quality by Topic 530, Quality by Domain 540 and Quality by Type 550. In order to help the viewer quickly access the business impact related to these grouping, under the groupings by topics there are various subheadings (and corresponding data under those subheadings) including (but not limited to) identifiers 532, 542, 552; Quality Score 534, 544, 554, which can be represented either numerically or graphically as shown; and Trend 536, 538, 546, 556, which can be represented symbolically 536, 546, 556 (e.g., with an up or down arrow), graphically 538, or with words (not shown). The point being that a viewer should be able to quickly view the screen and be able to access the business impact as it relates to the data being analyzed and not the particular representation of the data, which may be set based upon individual preferences.

Additionally, the representative Executive Score Card 500 also includes a section indicating the subscribed-to rules 560 of the particular user. Similar to the grouping, this section also includes various subheadings (and corresponding data under those subheadings) including (but not limited to) identifiers 562; Quality Score 564, which can be represented either numerically or graphically (or both as shown); and Trend 566, which can be represented symbolically (e.g., with an up or down arrow) and/or graphically as shown, or, in some variants, with words (not shown). The important point being that a viewer should be able to readily assess the business impact as it relates to the data being analyzed, not the particular representation of the data, which may be set based upon individual preferences.

Additionally, in order to help the viewer quickly assess the status of corrective actions taken, or in the process of being taken, the representative Executive Score Card 500 also includes sections related to incidents: an Incident Status 570 section and an Incidents % Closed 580 section. Incident Status 570 section includes various subheading (and corresponding data under those subheadings) including (but not limited to) identifiers 572, Date Open 574 and Status 576 (e.g., Open, Pending, Closed, etc.) to help the viewer to quickly access the situation. The Incidents % Closed 580 section may include a bar graph representing, in this example, the percentage of incidents opened Today 582, Yesterday 584, and within the Last 90 days 586 that have been closed. The time periods 582, 584, 586 are representative of typical time frames; however, other time frames including user specific time frames could also be implemented, the point being that the time frames should be appropriate to the particular business decision(s) at issue.

With respect to making business decisions, some of the business decisions that will be made involve the fact that remediation of the data needs to be performed. To this end, the Remediation Analysis Engine 470 of FIG. 4C, along with the Measures & Metrics repository 496 of FIG. 4D, provides the capabilities to do so and allows data metrics to be analyzed over time.

FIGS. 6A-6F illustrate, in simplified form, an example data analysis conducted according to the teachings herein. Specifically, FIGS. 6A-6F illustrate an example of performing record instance tracking, which allows the user to show the history for any of the record(s). This optional functionality, if incorporated, allows the user to track a single record, or a grouping of records, over multiple executions of a rule(s). For example, if a particular record failed a rule on Day 1, was fixed for Days 2 and 3, and reappeared as a failure in Day 4, the Remediation Analysis Engine 470 allows one to cross compare the actual instances of the record that failed a rule across the days and thereby confidently identify whether an issue was actually resolved or, if the issue has reappeared for one reason or another, to further investigate the reason for the intermittent error. This is accomplished by storing the records of each break in a rule and each subsequent execution involving those records and/or that rule.

By way of a more concrete example, FIG. 6A illustrates the output 600-1 from analysis of a data set using the approach described above. Each row 610a, 610b, 603c, 610d, 610e represents a record (made up of a “Key” 620 and four fields 630 of data 615) for which a break occurred somewhere in the data 615 during analysis of the data set according to a particular rule. Thereafter, remediation activities were performed.

At a point in time thereafter, the data set was analyzed in the exact manner that resulted in the output 600-1 of FIG. 6A. FIG. 6B shows the output 600-2 from that subsequent analysis of that data set (Execution 2). It is understood that the data sets need not be the exactly the same data sets, but they are assumed to have at least some overlapping data records. However, for simplicity, with this example, the data sets are presumed to be the same. As shown in FIG. 6B, the output 600-2 from the analysis of the data set identifies those records 610a, 610c, 610d, 610e, 610f that also had one or more breaks in connection with the rule being analyzed. Since the record corresponding to the record 610b of FIG. 6A that has the Key value of “B”, is not present, record 610b is considered a fixed record and would be part of a separate data output.

In that regard, FIG. 6C shows an output 600-3 identified as a “Fixed” records output. These “Fixed” records reflected in the output 600-3 are data records that had a break in a previous execution, in this case Execution 1 of FIG. 6A, but no longer have break associated with that record in a subsequent execution (e.g., Execution 2 of FIG. 6B). Advantageously, as part of the Alerts and Notification module 484 of the Configuration Management Engine 480 of FIG. 4C, users may opt to receive alerts from the system in, for example, the case where a record was previously fixed and then returns in a subsequent execution thereafter. Likewise, in some variants, in addition to or instead of alerts for “Fixed” records, a user may opt to obtain alerts for, for example, “New” breaks, “Unchanged” breaks and/or “Changed” breaks. “New” break alerts are alerts for breaks in data records that did not previously have a break. “Unchanged” break alerts indicate records where there was a break in an execution and the next subsequent execution. “Changed” break alerts indicate data records where a break occurs in two subsequent executions for the same record, but the data that caused the break is different.

FIG. 6D illustrates an example “New” records output 600-4 for such a data set. In this particular example, there is only a single record 610f with a Key value of “F” that had a break as a result of the analysis.

FIG. 6E illustrates an “Unchanged” records output 600-5 for an execution data set. In this particular example, outputs there are two records 610d, 610e with Key values of “D” and “E” are shown in the output 600-5 because they had the same break in two sequential executions.

FIG. 6F illustrates a “Changed” records output 600-6 for an execution data set. In this particular example, the output 600-6 data set includes an optional reporting feature whereby further execution-related information is provided, in this example, in the form of a “From-To” and “Execution Number” information. Thus, as shown in FIG. 6F, two break-related records 610a-1, 610c-1 show the “From” data and two break-related records 610a-2, 610c-2 show the “To” data so as to identify the change in the actual data 615a, 615b, 615c, 615d (highlighted in grey). In addition, as shown, the Key optionally additionally includes not only the record Key values (“A” and “C”), but also an execution indicator (Exec 1 and Exec 2). This is advantageous because, in actual implementation, one or more of these types of situations may be reported concurrently and reflect multiple iterations of execution.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A data quality analysis tool, comprising:
one or more processors, coupled to non-transient program and data storage, configured to operate, under the control of a non-transient program, the non-transient program comprising, when executed, to implement:
a Rules Engine, wherein the Rules Engine is configured to
i) allow one or more rules to be entered and stored in the data storage,
ii) receive a data set, comprised of one or more data record,
iii) determine whether any of the received data set meets at least one specific rule,
iv) for each instance where the at least one specific rule is met, determine one or more business impacts, and
v) allow a priority associated with each rule to be entered and stored in the data storage;
a Scoring Engine, wherein the Scoring Engine is configured to
i) for each of the at least one specific rule that has been met, determine a business impact score,
ii) apply a weighting factor to each of the one or more business impact scores to obtain a weighted business impact for each of the at least one specific rules, and
iii) prioritize and combine all of the weighted business impact scores into a total business impact score; and
a Configuration Management Engine, comprising an Alerts and Notification module, wherein the Configuration Management Engine is configured to provide notifications to a subscribed user via the Alerts and Notification module based upon a result of the Scoring Engine performing “iii)”.

2. The data quality analysis tool of claim 1, wherein the business impact score is determined using the formula
$$f ( I ) = {\sum }_{1}^{n} \frac{{I}_{i}}{{T}_{i}}$$
where f(I) is business impact score, Iᵢ is the business impact and Tᵢ is the total possible business impact over the records in the population.

3. The data quality analysis tool of claim 2, wherein each business impact score has associated with it a weighting factor and wherein the weighted business impact is obtained using the formula
$$f ( w ) = \frac{{\sum }_{1}^{n} f ( I ) \times {w}_{n}}{{\sum }_{1}^{n} {w}_{n}}$$
where f(w) is the weighted business impact for a particular rule; f(I) is the business impact score; and wₙ is the weighting factor associated with each business impact score.

4. The data quality analysis tool of claim 3, wherein each rule has associated with it a priority and the total business impact score is produced using the formula
$$f ( S ) = {\sum }_{1}^{n} f ( w ) \times f ( P )$$
where f(S) is the total business impact score, f(P) is a the priority associated with a particular rule, and f(w) is the weighted business impact for a particular rule.

5. The data quality analysis tool of claim 4, wherein f(P) is calculated using the following equation
$$f ( P ) = \frac{r - P + 1}{r}$$
where r is the number of rules the priority associated with a particular rule.

6. The data quality analysis tool of claim 1, further comprising:
a Remediation Analysis Engine configured to store records when a rule is met from one execution of the data quality tool to another and to compare sequential executions to determine one or more execution impacts based upon what records are different between the executions, what records are the same between the executions, and when the records are the same, an extent to which the same records contain the same data.

7. The data quality analysis tool of claim 1, wherein the Alerts and Notification module is configured to issue an alert based upon the one or more execution impacts meeting a predefined criteria.

8. The data quality analysis tool of claim 1, wherein the Configurations Management Engine is further configured to allow the predefined criteria to be individually set for an end user.

9. The data quality analysis tool of claim 1, wherein the business impact score for each rule is a function of the total possible business impact that could have occurred.

10. The data quality analysis tool of claim 1, wherein the Scoring Engine is further configured to normalize rule priority.

11. A computer implemented method for assessing the impact of data quality on a business, comprising:
retrieving, using a processor, at least two or more data quality rules, wherein each of the at least two or more data quality rules has a rule criteria that must be met and an association to instructions for determining at least one or more Impact Metrics;
retrieving, using the processor, a data set containing one or more data records;
analyzing, using the processor, the data set separately for each of the at least two or more data quality rules and determining, separately for each of the at least two or more data quality rules, using the associated instructions for determining the at least one or more Impact Metrics, one or more Impact Metrics according to the formula
$$f ( I ) = {\sum }_{1}^{n} \frac{{I}_{i}}{{T}_{i}}$$
where f(I) is Impact Metric, Iᵢ is the actual determined impact of the records meeting the rule criteria for the data quality rule, and Tᵢ is the total possible impact over the records in the population;
applying, using the processor, separately for each of the at least two or more data quality rules, a weighting factor applied to the at least one or more Impact Metrics and producing a weighted business impact according to the formula
$$f ( w ) = \frac{{\sum }_{1}^{n} f ( I ) \times {w}_{n}}{{\sum }_{1}^{n} {w}_{n}}$$
where f(w) is the weighted Impact Metric for a particular rule, against which the database is accessed; f(I) is the impact of an Impact Metric; and wₙ is the weighting factors for each metric;
calculating, using the processor, a total business impact score for the data set according to the formula
$$f ( S ) = {\sum }_{1}^{n} f ( w ) \times f ( P )$$
where f(P) is a rule priority applicable to each of the at least two or more data quality rules, wherein the total business impact score corresponds to the magnitude of impact on the business.

12. The method of claim 11, wherein f(P) is calculated using the following equation
$$f ( P ) = \frac{r - P + 1}{r}$$
where r is the number of rules and P is the priority of each of the at least two or more data quality rules.

13. The method of claim 11, wherein at least one of the data quality rules is a subscribed rule, with the subscribed rule having associated with it a list of one or more users, the method further comprising:
issuing an alert to the one or more users when the weighted business impact of the subscribed rule meets a predefined criteria.

14. The method of claim 13, wherein the predefined criteria is individualized to the one or more users.

15. The method of claim 11, wherein at least one of the data quality rules is a subscribed rule, with the subscribed rule having associated with it a list of one or more users, the method further comprising:
issuing an alert to the one or more users when the total business impact score meets a predefined criteria.

16. The method of claim 15, wherein the predefined criteria is individualized to the one or more users.

17. The method of claim 11, wherein the data set is a first data set, the total business impact score is a first total business impact score, and the rule criteria is a first rule criteria, and wherein one or more records for which the first rule criteria has been met is stored in a first data storage, wherein the analyzing further comprises:
calculating, using the processor, a second total business impact score for a second data set having at least some records in common with the first data set;
storing records of the second data set for which a second rule criteria has been met in second data storage;
comparing, using the processor, the first data storage to the second data storage to determine whether
i) any records are different between the first data storage and second data storage; and
ii) any records match between the first data storage and second data storage.

18. The method of claim 17, wherein, when any records match between the first data storage and the second data storage, the method further comprises:
accessing, using the processor, a list of one or more users that are subscribed to receive an alert based on a result of the comparing the first data storage to the second data storage meeting a predefined criteria; and
issuing an alert to the one or more users, using the processor, when the predefined criteria is met.

19. The method of claim 18, wherein the predefined criteria is individualized to the one or more users.
